(19) United States
(12) Patent Application Publication
(10) Pub. No.: US 2015/0272154 A1
(43) Pub. Date: Oct. 1, 2015

(54) Oil-And/Or-Fat Composition And Food

(71) Applicant: The Nisshin OilliO Group, Ltd., Tokyo (JP)

(72) Inventors: Takashi TOYOSHIMA, Yokosuka-shi (JP); Naohisa NOSAKA, Yokosuka-shi (JP); Michio KASAI, Yokosuka-shi (JP)

(21) Appl. No.: 14/633,075

(22) Filed: Feb. 26, 2015

(30) Foreign Application Priority Data
Mar. 26, 2014 (JP) 2014-064301

(51) Int. Cl. A23D 9/04

(52) U.S. Cl. CPC A23D 9/04

(57) ABSTRACT

The purpose of the invention is to provide an oil-and/or-fat composition including a roasted oil, the oil-and/or-fat composition having improved oxidation stability, and a food produced by using the oil-and/or-fat composition.

The oil-and/or-fat composition according to the invention includes therein 15 to 100% by mass of at least one roasted oil selected from the group consisting of a roasted soybean oil obtained by roasting soybeans at the roasting temperature of 220 to 300 degrees C. and a roasted rapeseed oil obtained by roasting rapeseeds at the roasting temperature of 210 to 300 degrees C.

The present application is based on Japanese patent application No. 2014-064301 filed on Mar. 26, 2014, the entire contents of which are incorporated herein by reference.

### BACKGROUND OF THE INVENTION

1. Field of the Invention

This invention relates to an oil-and/or-fat composition and a food, in particular, this invention relates to an oil-and/or-fat composition including a roasted oil and a food produced by using the oil-and/or-fat composition.

2. Description of the Related Art

An oil-and/or-fat composition is easily oxidized at the time of cooking accompanying heating such as fry cooking, stir-frying cooking, or during a long term storage, thus due to the oxidation, the quality of the oil-and/or-fat composition and the cooked product is deteriorated. Consequently, an oil-and/or-fat composition having high oxidation stability is required.

On the other hand, an oil-and/or-fat composition including a roasted oil is disclosed (for example, refer to JP-2006-204266 A1 and WO 2009/028483).

JP-2006-204266 A1 discloses an oil-and/or-fat composition including a roasted soybean oil and an animal and vegetable oil, the roasted soybean oil being obtained by applying a roasting processing to soybean at a roasting temperature of 120 to 200 degrees C., applying a moisture adjusting processing to the soybean roasted so as to have the content of moisture of 7 to 13% by mass, and then applying a squeezing processing to the soybean of which content of moisture is adjusted.

JP-2006-204266 A1 describes that according to the invention of JP-2006-204266 A1, a method for producing a roasted soybean oil and a roasted soybean oil can be provided, the method being capable of obtaining a soybean flavored oil having a favorable flavor peculiar to the soybean easily and in a high yield, and the roasted soybean oil being usable as a masking agent by being mixed with the other oils.

In addition, WO 2009/028483 discloses an oil-and/or-fat composition including a small amount of a roasted soybean oil obtained by roasting soybean at a roasting temperature of 130 to 220 degrees C. (paragraph 0095) or a roasted oil obtained by roasting rapeseed at a roasting temperature of 130 to 200 degrees C. (paragraph 0097).

WO 2009/028483 describes that according to the invention of WO 2009/028483, an occurrence of an unpleasant smell peculiar to raw materials can be prevented, the unpleasant smell being contained in an oil-and/or-fat such as soybean oil, palm based oil-and/or-fat, flux oil, perilla oil, and being exemplified as green smell, reversion flavor, and heating flavor in the soybean oil, and further since the content of the roasted oil is a small amount, a flavor of the roasted oil is not detected, thus the flavor of the roasted oil can be prevented from being transferred to the cooked products.

### SUMMARY OF THE INVENTION

There is a problem that the conventional roasted oil roasted at a roasting temperature of approximately 120 to 200 degrees C. may be deemed to be insufficient in oxidation stability.

Therefore, it is an object of the invention to provide an oil-and/or-fat composition including a roasted oil, the oil-and/or-fat composition having improved oxidation stability, and a food produced by using the oil-and/or-fat composition.

The invention provides the following [1] to [8] in order to achieve the above-mentioned object.

[1] An oil-and/or-fat composition, including therein 15 to 100% by mass of at least one roasted oil selected from the group consisting of a roasted soybean oil obtained by roasting soybeans at the roasting temperature of 220 to 300 degrees C. and a roasted rapeseed oil obtained by roasting rapeseeds at the roasting temperature of 210 to 300 degrees C.
[2] The oil-and/or-fat composition according to [1], wherein the roasted oil selected from the group is only the roasted soybean oil.
[3] The oil-and/or-fat composition according to [1] or [2], wherein the roasting temperature of the roasted soybean oil is 225 to 260 degrees C.
[4] The oil-and/or-fat composition according to [1], wherein the roasted oil selected from the group is only the roasted rapeseed oil.
[5] The oil-and/or-fat composition according to [1] or [4], wherein the roasting temperature of the roasted rapeseed oil is 220 to 260 degrees C.
[6] The oil-and/or-fat composition according to any one of [1] to [5], wherein the content of the roasted oil is 45 to 100% by mass.
[7] The oil-and/or-fat composition according to any one of [1] to [6], wherein the oil-and/or-fat composition is an oil-and/or-fat for heat cooking.
[8] A food produced by using the oil-and/or-fat composition according to any one of [1] to [7].

### Advantageous Effects of the Invention

According to the invention, an oil-and/or-fat composition including a roasted oil, the oil-and/or-fat composition having improved oxidation stability, and a food produced by using the oil-and/or-fat composition can be provided.

### DETAILED DESCRIPTION OF THE PREFERRED EMBODIMENTS

### Oil-and/or-Fat Composition

The oil-and/or-fat composition according to the embodiment of the invention includes therein 15 to 100% by mass of at least one roasted oil selected from the group consisting of a roasted soybean oil obtained by roasting soybeans at the roasting temperature of 220 to 300 degrees C. and a roasted rapeseed oil obtained by roasting rapeseeds at the roasting temperature of 210 to 300 degrees C.

### (Roasted Soybean Oil)

The roasted soybean oil included in the oil-and/or-fat composition according to the embodiment of the invention is obtained via a process of roasting soybeans of raw materials at the roasting temperature (product temperature) of 220 to 300 degrees C. The lower limit of the roasting temperature is preferably not less than 225 degrees C., and more preferably not less than 230 degrees C. On the other hand, the upper limit of the roasting temperature is preferably not more than 280 degrees C., more preferably not more than 270 degrees C., furthermore preferably not more than 260 degrees C., and the most preferably not more than 255 degrees C.

The roasting time differs dependent on the roasting temperature, the roasting processing amount, the roasting processing machine and the like, but the roasting is carried out preferably for approximately 1 to 30 minutes at the above-mentioned roasting temperature, more preferably for approximately 3 to 25 minutes, furthermore preferably for approximately 5 to 20 minutes. The method for increasing the temperature is not particularly limited, but it is preferred to gradually increase the temperature at a constant increase rate (for example, 10 to 20 degrees C. increase/minute).

The roasting method is not particularly limited, but for example, the roasting can be carried out by heating the soybean from the outside via superheated steam, electric heat, hot air, burner, microwave or the like. In addition, the roasting machine to be used is not particularly limited, but for example, a rotary fluidized-bed type, a rotary drum type, a rotary kiln type or the like can be used.

As the soybean of raw materials, natural soybean (soybean not particularly processed), pulverized soybean, cracked soybean or depressed soybean can be used. In addition, as a kind of soybean, U.S. soybeans for food (IOM: abbreviation of Indiana, Ohio, Michigan), U.S. soybeans for ordinary oil expression (ordinary), domestic soybeans, Brazilian soybeans, Chinese soybeans or the like can be used, and the soybeans can be used without depending on whether the soybeans are genetically recombined soybeans or non-genetically recombined soybeans.

The oil-and/or-fat composition according to the embodiment of the invention includes therein 15 to 100% by mass of at least one roasted oil selected from the group consisting of the above-mentioned roasted soybean oil and the roasted rapeseed oil described below. Namely, any case of including only the roasted soybean oil, including only the roasted rapeseed oil or including the roasted soybean oil and the roasted rapeseed oil may be adopted. The lower limit of the content of the roasted oil (the total amount of the roasted soybean oil and the roasted rapeseed oil) in the oil-and/or-fat composition is preferably not less than 20% by mass, more preferably not less than 30% by mass, furthermore preferably not less than 40% by mass, and the most preferably not less than 45% by mass. In case that the content of the roasted oil in the oil-and/or-fat composition is less than 15% by mass, the advantageous effect of the invention (the enhancement of oxidation stability) is hardly obtained.

The soybean to which the roasting processing is applied is mechanically squeezed by a squeezer so that the oil is squeezed out. By filtering the oil, the roasted soybean oil (squeezed crude oil) is obtained.

The squeezer is not needed to be a squeezer of a specific type, but for example, an expeller type squeezer including a casing formed in a cylindrical shape and a screw rotatably disposed inside of the casing can be appropriately used. The number of rotations and processing amount can be appropriately adjusted.

In addition to the squeezing processing, or instead of the squeezing processing, an extraction processing using an organic solvent such as hexane and subsequent removal processing of the organic solvent by distilling under reduced pressure are applied thereto, thereby the roasted soybean oil (extracted crude oil) may be obtained. The extraction processing can be carried out by using a known method.

The roasted soybean oil (squeezed crude oil or extracted crude oil) obtained can be also used as it is, but it is preferable that the roasted soybean oil is centrifuged by a centrifugal separator under the conditions that the temperature is 70 to 110 degrees C. and the addition amount of water is 3% by mass (to the crude oil), thereby a degumming treatment (hereinafter, referred to as water degumming treatment) is carried out, and the filtering is applied thereto again. Due to this, the roasted soybean oil (original oil: water degummed oil) can be obtained.

The roasted soybean oil obtained as mentioned above can be supplied for food without purification treatment such as deoxidation treatment, decolorization treatment, deodorization treatment. Of course, the above-mentioned treatments can be also carried out by a general method, but in case of the squeezed crude oil, it is preferable that the treatments are not carried out for the purpose of making good use of the flavor thereof, and in case of the extracted crude oil, it is preferable that the deodorization treatment is carried out in terms of removal of the organic solvent.

### (Roasted Rapeseed Oil)

The roasted rapeseed oil included in the oil-and/or-fat composition according to the embodiment of the invention is obtained via a process of roasting rapeseeds of raw materials at the roasting temperature (product temperature) of 210 to 300 degrees C. The lower limit of the roasting temperature is preferably not less than 220 degrees C., more preferably not less than 225 degrees C., and furthermore preferably not less than 230 degrees C. On the other hand, the upper limit of the roasting temperature is preferably not more than 280 degrees C., more preferably not more than 270 degrees C., furthermore preferably not more than 260 degrees C., and the most preferably not more than 255 degrees C.

The same roasting time and roasting method as those in the case of the above-mentioned roasted soybean oil can be adopted. In addition, the same squeezing or extraction method, degumming treatment method and purification treatment method as those in the case of the above-mentioned roasted soybean oil can be also adopted.

The rapeseeds as raw materials are not particularly limited, but various breeds of rapeseeds used for producing edible oils can be used. A breed of rapeseed called as “Canola” produced by improvement of breeds can be of course used.

### (Other Oil-and/or-Fats in Oil-and/or-Fat Composition)

The oil-and/or-fat composition according to the embodiment of the invention can include usual edible oil-and/or-fats other than the above-mentioned roasted oil (the roasted soybean oil and the roasted rapeseed oil). As the usual edible oil-and/or-fats, soybean oil, rapeseed oil, high-oleic acid rapeseed oil, corn oil, sesame oil, shiso oil (perilla oil), linseed oil, peanut oil, safflower oil, high-oleic acid safflower oil, sunflower oil, high-oleic acid sunflower oil, cottonseed oil, grape seed oil, macadamia nut oil, hazelnut oil, pumpkin seed oil, walnut oil, camellia oil, tea seed oil, egoma oil (perilla oil), borage seed oil, olive oil, rice oil, rice bran oil, wheat embryos oil, palm oil, palm kernel oil, coconut oil, cocoa butter, beef tallow, lard, chicken grease, milk fat, fish oil, seal oil, algae oil, these oil-and/or-fats low-saturated by improvement of breeds, these oil-and/or-fats fractionated, these oil-and/or-fats hydrogenated, these oil-and/or-fats transesterified and the like can be included, and the mixture of the above-mentioned oil-and/or-fats may be also used. It is preferable that these edible oil-and/or-fats are purified oils, and those are unroasted oils.

### (Other Ingredients in Oil-and/or-Fat Composition)

In the oil-and/or-fat composition according to the embodiment of the invention, for example, antioxidants such as tocopherols, ascorbyl palmitate, carotenes; emulsifiers such as polyglycerol fatty acid esters, organic acid monoglycerides, polysorbates, sugar esters, fatty acid monoglycerides, sorbitan fatty acid esters, propylene glycol fatty acid esters, lecithin; and antifoaming agents such as silicone oils can be added thereto so long as the advantageous effect of the invention is provided.

### (Application)

The oil-and/or-fat composition according to the embodiment of the invention has a roasted flavor and is capable of enhancing oxidation stability in spite of including the roasted oil, thus the oil-and/or-fat composition can be appropriately used as an oil-and/or-fat for heat cooking such as frying oil, stir-frying oil, spraying oil and the like.

### (Food)

The food according to the embodiment of the invention is characterized in that the food is produced by using the above-mentioned oil-and/or-fat composition according to the embodiment of the invention. As the food, for example, fried food, tempura (battered and deep fried food), stir-fried food, rice cracker, confectionery, dressing, mayonnaise, margarine, fat spread, shortening and the like can be included. The above-mentioned foods can be produced by a known routine procedure.

Next, the invention will be explained by Examples, but the invention is not limited by Examples at all.

### Examples

### Experiment 1

A water oven for domestic use (trade name: Healsio AX-HC1, manufactured by Sharp corporation) was preheated so as to increase the internal temperature thereof to each roasting temperature shown in Table 1, and then 100 g of soybeans as raw materials (soybeans sheathed with hull) were mounted on a tray in the oven so as to be roasted for 10 minutes. The soybeans as raw materials roasted were pulverized so as to be extracted by hexane, and then hexane was removed under reduced pressure (60 to 100 degrees C.) so as to obtain a roasted soybean oil (extracted crude oil). In Comparative Example 1A, soybeans as raw materials un-roasted were pulverized so as to be extracted by hexane, and then hexane was removed under reduced pressure (60 to 100 degrees C.) so as to obtain a roasted soybean oil (extracted crude oil). The water degumming treatment was applied by the above-mentioned method to the extracted crude oil obtained so as to obtain a roasted soybean oil (original oil: water degummed oil), and then the following oxidation stability test was carried out.

As the oxidation stability test of oil-and/or-fat, a CDM (Conductometric Determination Method) test was carried out in accordance with Standard Methods for the Analysis of Fats, Oils and Related Materials (2. 5. 1. 2-1996). An automatic oil-and/or-fat stability testing device (Rancimat 743 model, manufactured by Metrohm Sibata) was used.

### (Method of CDM Test)

While heating an oil-and/or-fat (sample) in a reaction vessel at the temperature of 120 degrees C., clean air was supplied thereto. Volatile decomposition products generated due to oxidation was collected in water, a time till a bending point at which electric conductivity of the water is drastically changed was measured. The measurement result shows that the larger the numerical value (hour) is, the better the oxidation stability is.

TABLE 1

| | Com. Ex. | Com. Ex. | Com. Ex. | Com. Ex. | Com. Ex. | Com. Ex. | Example | Example |
|---|---|---|---|---|---|---|---|---|
| | 1A | 2A | 3A | 4A | 5A | 6A | 1A | 2A |
| Roasting | Un-roasted | 130 | 150 | 170 | 190 | 210 | 230 | 250 |
| temperature | | | | | | | | |
| (° C.) | | | | | | | | |
| CDM test | 2.5 | 3.4 | 3.5 | 3.5 | 3.3 | 3.7 | 5.3 | 7.5 |
| result (hour) | | | | | | | | |

Com. Ex.: Comparative Example

### Experiment 2

A water oven for domestic use (trade name: Healsio AX-HC1, manufactured by Sharp corporation) was preheated so as to increase the internal temperature thereof to 250 degrees C. and then 100 g of soybeans as raw materials (peeled, coarsely crushed soybeans) were mounted on a tray in the oven so as to be roasted for 20 minutes. The soybeans as raw materials roasted were pulverized so as to be extracted by hexane, and then hexane was removed under reduced pressure (60 to 100 degrees C.) so as to obtain a roasted soybean oil (extracted crude oil). The water degumming treatment was applied by the above-mentioned method to the extracted crude oil obtained so as to obtain a roasted soybean oil (original oil: water degummed oil), and then the oxidation stability test (CDM test) was carried out similarly to Experiment 1.

TABLE 2

| | Example | Example |
|---|---|---|
| | 2A | 3A |
| Roasting temperature | 250 | 250 |
| (° C.) | | |
| Roasting time | 10 | 20 |
| (minute) | | |
| CDM test result | 7.5 | 16.9 |
| (hour) | | |

### Experiment 3

A water oven for domestic use (trade name: Healsio AX-HC1, manufactured by Sharp corporation) was preheated so as to increase the internal temperature thereof to each roasting temperature shown in Table 3, and then 100 g of rapeseeds as raw materials were mounted on a tray in the oven so as to be roasted for 10 minutes. The rapeseeds as raw materials roasted were pulverized so as to be extracted by hexane, and then hexane was removed under reduced pressure (60 to 100 degrees C.) so as to obtain a roasted rapeseed oil (extracted crude oil). In Comparative Example 1B, rapeseeds as raw materials un-roasted were pulverized so as to be extracted by hexane, and then hexane was removed under reduced pressure (60 to 100 degrees C.) so as to obtain a roasted rapeseed oil (extracted crude oil). The water degumming treatment was applied by the above-mentioned method to the extracted crude oil obtained so as to obtain a roasted rapeseed oil (original oil: water degummed oil), and then the oxidation stability test (CDM test) was carried out similarly to Experiment 1.

TABLE 3

| | Com. | Com. | | | |
|---|---|---|---|---|---|
| | Ex. | Ex. | Example | Example | Example |
| | 1B | 2B | 1B | 2B | 3B |
| Roasting | Un-roasted | 190 | 210 | 230 | 250 |
| temperature | | | | | |
| (° C.) | | | | | |
| CDM test | 2.7 | 7.4 | 8.5 | 13.5 | 19.9 |
| result (hour) | | | | | |

Com. Ex.: Comparative Example

### Experiment 4

A water oven for domestic use (trade name: Healsio AX-HC1, manufactured by Sharp corporation) was preheated so as to increase the internal temperature thereof to 250 degrees C., and then 100 g of soybeans as raw materials (soybeans sheathed with hull) were mounted on a tray in the oven so as to be roasted for 10 minutes. The soybeans as raw materials roasted were pulverized so as to be extracted by hexane, and then hexane was removed under reduced pressure (60 to 100 degrees C.) so as to obtain a roasted soybean oil (extracted crude oil). The water degumming treatment was applied by the above-mentioned method to the extracted crude oil obtained. An un-roasted soybean product oil (trade name: Soybean salad oil, manufactured by the Nisshin OilliO Group Ltd.) (purified oil) was blended at the blending ratio shown in Table 4 with the roasted soybean oil (original oil: water degumed oil) obtained, and then the oxidation stability test (CMD test) was carried out similarly to Experiment 1.

TABLE 4

| | Com. | Com. | Exam- | Exam- | Exam- | Exam- | Exam- |
|---|---|---|---|---|---|---|---|
| | Ex. | Ex. | ple | ple | ple | ple | ple |
| | 1C | 2C | 1C | 2C | 3C | 4C | 5C |
| Blend- | 100/0 | 90/10 | 80/20 | 70/30 | 60/40 | 50/50 | 0/100 |
| ing | | | | | | | |
| ratio | | | | | | | |
| (product | | | | | | | |
| oil/ | | | | | | | |
| roasted | | | | | | | |
| oil) | | | | | | | |
| CDM | 4.0 | 4.0 | 4.3 | 4.5 | 4.6 | 5.2 | 7.8 |
| test | | | | | | | |
| result | | | | | | | |
| (hour) | | | | | | | |

Com. Ex.: Comparative Example

The oil-and/or-fat of Comparative Example 1C (soybean product oil/roasted soybean oil=100/0) does not have a savory flavor when put into the mouth, and does not have also a roasted flavor, to the contrary, any of the oil-and/or-fat compositions of Examples 1C to 5C has a savory flavor when put into the mouth, and has also a roasted flavor.

What is claimed is:

1. An oil-and/or-fat composition, comprising:
15 to 100% by mass of at least one roasted oil selected from the group consisting of a roasted soybean oil obtained by roasting soybeans at the roasting temperature of 220 to 300 degrees C. and a roasted rapeseed oil obtained by roasting rapeseeds at the roasting temperature of 210 to 300 degrees C.

2. The oil-and/or-fat composition according to claim 1, wherein the roasted oil selected from the group is only the roasted soybean oil.

3. The oil-and/or-fat composition according to claim 1, wherein the roasting temperature of the roasted soybean oil is 225 to 260 degrees

4. The oil-and/or-fat composition according to claim 2, wherein the roasting temperature of the roasted soybean oil is 225 to 260 degrees

5. The oil-and/or-fat composition according to claim 1, wherein the roasted oil selected from the group is only the roasted rapeseed oil

6. The oil-and/or-fat composition according to claim 1, wherein the roasting temperature of the roasted rapeseed oil is 220 to 260 degrees C.

7. The oil-and/or-fat composition according to claim 5, wherein the roasting temperature of the roasted rapeseed oil is 220 to 260 degrees C.

8. The oil-and/or-fat composition according to claim 1, wherein the content of the roasted oil is 45 to 100% by mass.

9. The oil-and/or-fat composition according to claim 1, wherein the oil-and/or-fat composition is an oil-and/or-fat for heat cooking.

10. A food produced by using the oil-and/or-fat composition according to claim 1.
